(19) United States
(12) Patent Application Publication
(10) Pub. No.: US 2014/0280595 A1
(43) Pub. Date: Sep. 18, 2014

(54) Cloud Based Elastic Load Allocation for Multi-media Conferencing

(71) Applicant: Polycom, Inc., San Jose, CA (US)

(72) Inventors: Mahalingam Mani, Cupertino, CA (US); Joseph Provine, Fremont, CA (US); Alon Klein, Herzeliya (IL); Ankit Bhandari, Jaipur (IN)

(21) Appl. No.: 14/213,454

(22) Filed: Mar. 14, 2014

Related U.S. Application Data
(60) Provisional application No. 61/791,428, filed on Mar. 15, 2013.

(51) Int. Cl. H04L 29/06

(52) U.S. Cl. CPC H04L 65/403
USPC 709/204

(57) ABSTRACT

Disclosed herein is a technique for providing cloud based scaleable videoconferencing infrastructure in a variety of ways. A combination of hardware based conferencing and software emulation of hardware conferencing equipment is disclosed. The disclosed systems and methods include load balancing algorithms and a software control architecture to allow for flexible and elastic scaling of each component individually or as a group. The disclosed systems and methods are also agnostic to the underlying hardware infrastructure utilized for any given conference.

### BACKGROUND

Business environments often include a number of meetings of personnel. Historically the availability for conferencing was limited to available infrastructure. The inflexible nature of this limitation has created problems reacting to varying conference demands.

### BRIEF DESCRIPTION OF THE DRAWINGS

Exemplary embodiments of the present invention will be more readily understood from reading the following description and by reference to the accompanying drawings, in which:

FIG. 1 illustrates XMPP Service Connections according to one or more disclosed embodiments.

FIG. 2 illustrates in a resource manager framework according to one or more disclosed embodiments.

FIG. 3 illustrates a potential set of architectural components and their interaction according to one or more disclosed embodiments.

FIG. 4 illustrates a block diagram of a hierarchy of functions associated with tiered load balancing according to one or more disclosed embodiments.

FIG. 5 illustrates a high-level architectural model according to one or more disclosed embodiments.

FIGS. 6-10 are diagrams to illustrate potential interactivity amongst portions of the disclosed reference model according to one or more disclosed embodiment.

FIG. 11 illustrates a possible deployment view of a licensing model according to one or more disclosed embodiments.

FIGS. 12-21 illustrate details of one example technical embodiment disclosed here in.

FIG. 22 illustrates an example load balancing of a conference server according to one or more disclosed embodiments.

FIG. 23 illustrates a flow chart of constant cost routing of a participant session to a destination DMA according to one or more disclosed embodiments.

FIGS. 24A-D illustrate timeline diagrams in conjunction with the users joining a conference call according to one or more disclosed embodiments.

### DETAILED DESCRIPTION

With the advent of Cloud Computing models it may now be possible to offer scalable on-demand conferencing capabilities that utilize concepts of newer technology. Disclosed herein are novel concepts for dynamically and elastically realizing use of virtual raw on-demand resources with scaling capabilities specifically designed to requirements of quality video conferencing needs without regard to previously required constraints of human intervention, specific processor capabilities, network connections, and the like. Requirements can include a number of users of a video conference and their individual video quality requirements.

The subject matter of this disclosure is related to subject matter disclosed in U.S. Pat. Nos. 7,975,073; 7,701,926; 7,174,365; and 7,113,992 each of which is incorporated by reference in its entirety for all purposes.

The following description is illustrative of several distinct embodiments which could be configured to work together in many different combinations. Disclosed embodiments are not restrictive. Many variations of the invention will become apparent to those skilled in the art upon review of this disclosure. The scope of the invention should therefore be determined not with reference to the above description, but instead with reference to the appended claims along with their full scope of equivalents.

### First Embodiment

In a first embodiment (See FIG. 1 diagram 100), a method and apparatus for Contacts-Integration from various (optionally Presence-based) internet social-apps into a unified dynamic contact list (from which participants can be invited into a video collaboration session) is described. Facilitating a meeting that allows the meeting organizer to choose online participants from across various internet domains can be problematic. This can be addressed by establishing a Federation-based application where the application subscribes to various administrative domains for federation. Social Connectors can facilitate a ‘public’ domain subscribed to by individual users on the internet with shared interests in the agenda of the network's community. Facilitating a meeting that allows the meeting organizer to choose online participants from across various social networks has been a slightly different subset of this problem. Social networks typically have a membership of broad base of end-users across the internet and work by rules of engagement defined by that network: they offer a visibility into a vast end-user community—including their online presence in most such networks—that facilitates socio-enterprise collaboration of the B2C kind that has become valuable for Contact Center and other UC-based customer relationship management (CRM) interfaces. Each of the social networks has their own standards for presence and video conferencing capabilities and the users of today do not have a choice to create a meeting across various social networks. Disclosed embodiments let users (hosts or meeting organizers) easily add anyone on Skype, Facebook, Google Talk and other business video apps to their video conferences from either a stand-alone application or the browser. In various embodiments this is accomplished using web browser plugins (105).

In one example, the plugin (105) has the following features to achieve its objectives:

1) Leveraging presence on IM/social networks: This feature facilitates user authentication to respective XMPP networks (110, 115), establishes the user's own presence and presence for their contacts, sends and receives XMPP chat messages over the XMPP servers involved to initiate and end the video collaboration session. Additionally, when federating with Skype™ contacts, this feature can leverage the com bridge facilitated by Skype4COM API to communicate with an end point installed Skype™ application to federate with the user's Skype™ contacts as well as to send and receive the chat messages. The video conference will then occur with each use using his designated application such as, Skype, Google Talk, desktop video conferencing software, or the like, with the conference bridge doing any necessary protocol handshaking.

2) Communication with Video Conferencing servers: The plugin can authenticate the user on a video conferencing server account management gateway (120) and further communicate with available server based APIs (e.g., Polycom server's REST API through http request/response mechanism) to create and terminate a video collaboration session.

3) Plugin-Browser bidirectional communication: Plugin's browser bridge can enable its communications with the browser during the video collaboration lifecycle and save client specific plugin settings like a list of social and instant messaging networks a user wishes to leverage etc. at the client's end.

Advantages of this disclosed embodiment include a highly scalable solution with no reinvestment cost on the existing infrastructure. End users or their contacts need not migrate to other platforms to facilitate video collaboration. Therefore a client-driven solution is disclosed that has better scalability by not relying on a particular server to establish/route communications to the social networks and their clients.

### Second Embodiment

In a second embodiment (see FIG. 2 block diagram 200), a method and apparatus for policy-based adaptive proportional elastic integration of video subsystems is disclosed. Video media processing between multi-parties with current technology of advanced video coding (AVC) can be compute-intensive—usually centrally managed only with hardware-accelerators. Software manifestations can take advantage of processor advances supporting video-primitives in virtualized platforms to make software media instances feasible. This second embodiment is described relative to a distributed client-server framework and has three components. Firstly, a resource manager (ARM) 205 is central to all subsystems and consists of several “brokers” to perform functions for the different components. The app-specific broker comprises: plugins that make app-specific intelligence decisions based on resource-updates from ARM agents (see below). The Agents may provide updates related to dependent subsystems as well as their own. They do so to their peer broker plugins through suitable ARM APIs (RESTful). The brokers may also notify the governing Agent for the subsystem notifying about adding to (or releasing from) instance to its subsystem's instance array or its dependent subsystem. The broker can make the determination based on the nature of the subsystem's state. The Agent itself can obtain state of its instance loads through its native mechanism(s). The plugin framework can interface to the DC (datacenter) Resource Pool of any infrastructure (e.g., vSphere, vCloud, EC2) through exposed APIs. The broker may communicate with other peer brokers to correlate resource-information for pre-allocation or post-deallocation. The broker can retain long-term patterns of allocation for analytics and adapting its broker policies as needed. The broker's decision can lead to its acting to requisition resources from the datacenter; or notification to subsystem to start quiescing low-usage instances in preparation for release-back to the DC pool. The algorithms governing the pool and policies thereof can be configured by the system manager through the element manager of ARM. Any changes to policies or adaptations through a feedback loop from analytics may be effected administratively or automatically (self-governing). Secondly, an Application-embedded ARM Agent can serve as the reporting client to the Broker peer in ARM. Finally, there is also an Intelligence component that may correlate loads between ARM instances between regions in the event of enacting follow-the-sun load-balancing and conference-participant regional balances. The disclosed embodiment can also drive up demand-based elasticity by back-pressure in the other direction media->session-->AS. The decisions are distributed between the actors (media, session, AS) acting as clients with ARM (A Resource Manager) serving as the server and bridging to a multiplicity of infrastructures (virtualized DC based on DC resource-pools such as vsphere DRS; vCloud Director; and virtualized Cloud-compute resources pools).

This embodiment describes a tightly coupled mechanism integrating both application-driven elasticity on a per-subsystem basis and a resource-binding of connectivity, trust-management and mutual authentication along with cross configuration across layers of (Unified Communication) subsystems. The application-driven elasticity can utilize a session manager subsystem, MCU (media) subsystem, and a recording subsystem. The session manager subsystem can use its per-instance capacity to decide how many instances it should requisition to allocate-ahead and how far ahead; conversely, how many idle instances it needs to retire that are idling for over a set period of time and are marked for release. The MCU subsystem can use its per-MCU load of compute-intensive AVC applications and relay-switching SVC clients to decide how many instances it needs to instantiate-ahead or release-behind based on dynamic loads. It then can get associated/disassociated with corresponding session manager instances that drive traffic through them. The recording subsystem can use its algorithm suited to its usage such as number of conferences under recording in an instance. This can also depend on whether live-streaming is associated with the recording and whether parallel transcoding is in progress. These criteria can be used to acquire or release new instances of the recording subsystem. The resource-binding requirements above can take into account that each subsystem has a dependency or has one or more subsystems depending on it to serve in the solution. The MCU needs to know and bind to the recording subsystem as necessary; the session manager needs to know MCUs to load-balance media sessions on and so on. Therefore, when an instance of a subsystem is acquired or released they can be “stitched” to the fabric of the entire solution to flow work through. This ‘resource-binding’ is analogous to SDN but not the same because SDN deals with network-level and transport-level bindings at the maximum—which is effectively already provided by the IaaS and this method builds on top of it to effect the app-level, into a load-balanced framework governing each subsystem. The above referred actions are coordinated across multiple service layers (viz., access, application, session and media) through an orchestration service (ARM) that insulates the subsystems from the underlying Cloud interface and architecture—making the system agnostic to different cloud-types.

Please also refer to the end of this disclosure for a more detailed discussion of disclosed technical embodiments.

### Third Embodiment

In a third embodiment, a method and apparatus for Adaptive Elastic Stacking of Multipoint Control Units is disclosed (see FIG. 3 diagram 300). In a cloud-based Video-centric UC infrastructure that uses software-based virtualized soft MCUs—capacity can be a challenge even with large cluster configurations. Capacity limitations can negatively affect the user experience of conferences that tend to be large-participant events or even medium-participant (with all-HD 720p or higher quality video)—as multiple MCUs are forced to be in a configuration known as cascading or daisy-chaining Cascading a conference can involve ‘bridging’ participants hosted in one MCU with those in another MCU. Such cascading may also be forced when MCU resource fragmentation across multiple conferences arise. Cascading can involve low-bandwidth connectivity that cannot take advantage of high-bandwidth interactions available inside compute elements within an MCU. This can lead to optimizing the transcoding and tiling operations to within an MCU and treating the aggregated output of an MCU to be a single input in for others; and other similar bandwidth-reducing actions leading to degraded user experience and resolution. Prior art solutions rely on high-bandwidth network-based physical interconnects MCUs (such as 1 Gbit dedicated or 10 Gb dedicated interconnects) that can then be added on-the-fly to create a bigger MCU configuration; and release them when no longer required. What is needed is a more flexible and less manual loosely-coupled elastic stacking of MCUs.

Stacking architecture of a stackable MCU consists of a MC (a media controller 305) that serves as a conventional MCU control-plane; in addition to discovering and configuring MCU blocks 310 that are the workhorses for (audio, video; AVC/SVC) media processing. Different possible architectures are shown in this disclosure and prior-art techniques are disclosed in the above referenced patents. Disclosed embodiments have MCU blocks 310 that can be added on-demand as VMs (or even VM-cluster-compute-instance). The VMs can be dynamically associated into a ‘MCU-cluster’ resulting in a variable-size stackable MCU. The MC 305 performs the additional role of understanding and performing the association as media-blocks get added or removed based on decisions made. These decisions can be made by the MCU itself—when it discovers that it is running out of MCU capacity and explicitly requisitions a VM instance that is imaged (initialized) as a MCU Block Virtual Machine (VM). (This may be a pre-allocated MCU idling and being brought into active service to avoid latencies in such an expansion; likewise, the removal may be effected by quiescing a MCU block 310 until it is drained from active use). Thus the MC component can take on these additional roles in addition to being the resource-requesting client. Alternatively, a Session Manager (SM) 315 can be utilized to instantiate explicitly. Session managers can instantiate MCU resources, as needed, when it is the external entity requisitioning and control the need for a flexible pool of resources. Thus—the capacity-aware SM can control the stacking control as opposed to MCU itself. Thirdly, the decisions can be administratively provisioned—this may be suitable for small deployments. Administrative provisioning can allow for manual overrides and on-demand provisioning for small unscheduled bursts. The disclosed embodiments can include an ARM 205 (A Resource Manager—discussed above) facilitating elastic-stacking requests from a governing Session Manager 315 (One implementation performing some of the functions of a Session Manager 315 is called a distributed media application (DMA)), through on-demand requests from the MCU-complex itself; or through administrative intervention.

### Fourth Embodiment

In a fourth embodiment (see FIG. 4 diagram 400), a linearly scalable method for in an Elastic Distributed Cluster for Real-time Communication is disclosed. In large scale Public Cloud deployments for communication services, the load can be highly time-variant as well as massive in scale. Prior-art approaches sometimes use load-balancing which distributes processing across multiple instances of physical servers. Typical Service Provider deployments use a large number of static load-balanced service instances. Load-balancing across a fixed set of instances can be handled through many types of policies, LU, LRU, round-robin, weighted.

In contrast, the pay-as-you-go Public-Compute-Cloud environment—a large number of instances can be requisitioned on-demand and released likewise as demand ebbs: load-balancing policies in such an elastic environment can be compounded by the fact that they should be able to continue to direct traffic from stateful sessions to the same entity regardless of possible on-the-fly additions/deletions of new/unused instances. Real-time communications scenario can be even more complex with multiple protocols (SIP & H.323) and elements having three different protocols (UDP, TCP and TLS) the last two being stateful transports. In video-conference (and audio) scenarios the considerations of such load-balancing can be yet even more compounded by aggregating a mixture of such signaling sessions into a specific instance and the conferencing parameters and their use in disclosed embodiments can offer new opportunities to address these and other problems.

In this embodiment, a component which can help in load balancing and scalability of the conference server decouples the conference room-map from the conference server system and places it on a globally accessible table. This table can also be reproduced across multiple regions of the Cloud. Updates to the table entries can be synchronized—asynchronously and atomically to keep a constant cost of searching and synchronization with multiple regions. In one example, data can be partitioned into a globally accessible table. Also, using ephemeral VMR (Virtual Meeting Room) on the distributed media application (DMA) 315, can help in decoupling the actual VMR (that user 405 dials) and the ephemeral VMR (Session director 410 can select to host that conference call). Conference stickiness can assist in the problem of load balancing in which newly added (or selected) DMA instances 315 can host the already running conference without disturbing existing conference participants. Stickiness can be distinct at the SIP-level and independent of signaling protocol (SIP/H.323) and independent of transport (UDP, TCP or TLS). A global-table of VMRs with a sub-range of VMRs can be assigned to home each region. For reasons of High Availability and Failover (HA), (a constant number of) regions backup every other region. When an message/request comes in—a decision can be made to place the new session in the requested VMR to the load-balancer (which is usually one—though may be distributed among may load-balancers themselves—each with a set of servers it balances across). This process can involve a lookup of the table to, in part, check to see if a VMR is already placed as a result of a prior join to the destination. Also, if the entry is owned by another region the requeste can be redirected to that region's load-balancer. An empty entry can now initialize the entry with the DMA that the LB decided to place it under (one of its DMAs). Each LB can have an array of DMAs it controls and hence be addressed by the DMA# in the subset of the array. The entry update, if any, can be asynchronously pushed to backup regions. The request, if not the first for that destination, can now be routed to the destination. Alternatively, if first for that source, the request can cause updates to the reference-count field of the entry and attach the source to the table-entry. Each table entry can consist of several fields based on VMR or DMA index for example.

The table can be indexed based on VMR (which can be a compressed table aided by hashing to help sparse entries). Each table entry can consist of several fields including a DMA field. Each DMA in the site-cluster in a given site known by its number and IP address as well as its association to the given DMA director/LB if associated in a conference cal. A reference count field for number of participant-sessions in that conference. An outstanding capacity field for the DMA describing the number of additional sessions possible. A low/high watermart count to indicate DMA-empty or DMA-full status respectively.

One algorithm to assist a conference is to check to see if the session request is to a confID that is locally homed (or a remote site) and if remote to forward to remote Session Director (SD). At local—lookup table entry for confID to be free or already busy. If not busy engate in a placement algorithm to identify a DMA to place the conference into. Select a last used DMA if space for the DMA is greater than or equal to the expected size of the converence. Otherwise, select another DMA with space greater than or equal to the expected size of DMA. These can be driven off a free space table that chains DMAs of different free space. If neither of these are available select an unused DMA. Update the conference table to reflect the selection made. After placement increment the reference count on the selected DMA and adjust DMA position in freespace table. Please see FIGS. 22-27 and their supporting text below.

### Additional Example Details for Above First Through Fourth Embodiments

What follows is a more detailed discussion of the embodiments disclosed here in the context of a design specification. Any specific details mentioned are relative to one possible embodiment and are not intended to be limiting. One of ordinary skill in the art, given the benefit of this disclosure, will realize that different design options are available based on other criteria and may differ from one specific implementation to another implementation.

Terminology

| Term/ | | |
|---|---|---|
| Acronym | Description | Comments |
| Cloud | A model for enabling ubiquitous, convenient, on-demand | |
| Computing | network access to a shared pool of configurable computing | |
| | resources (e.g., networks, servers, storage, applications, and | |
| | services) that can be rapidly provisioned and released with | |
| | minimal management effort or service provider interaction. | |
| IaaS | Infrastructure as a Service. A computing model that facilitates | |
| | hosting specific computing environments as a metered on- | |
| | demand internet Service. | |
| PaaS | Platform as a Service. A computing model that offers hosting | |
| | applications on well-known virtualized platforms as a metered | |
| | on-demand internet Service. The compute-hardware, storage | |
| | and network infrastructure are provided by the service. | |
| SaaS | Software as a Service. A computing model that offers hosted | |
| | applications for use as a metered on-demand internet Service. | |
| | The required compute-hardware, storage, network | |
| | infrastructure, OS and applications are provided by the service. | |
| VaaS | Video-centric Unified Communications for multimedia | |
| | collaboration, messaging, content delivery and management | |
| | and related application enablement interfaces thereof | |
| M-TLS | Mutual TLS. This implies use of X509v3 digital certificates as | |
| | credentials by both peers to establish a TLS session. | |
| Burst- | When the usage level exceeds the capacity of a system; one | |
| capacity | may burst or bridge (seamlessly) into a larger infrastructure; | |
| | such as into a Cloud-hosted deployment; or a Cloud can burst | |
| | into a self-hosted deployment. | |
| Tenant | The Akash context of tenant refers to the first level | |
| | (institutional or) bulk subscriber to VaaS services; the tenant | |
| | positions these VaaS services possibly among other broader | |
| | ranges of UC and other communication services to the end-user | |
| | (which in turn could be another tenant—an MSP itself, a | |
| | large/medium/small enterprise, or even end-user). | |
| Subscriber | Refers to the unit of end-user (or organization) that actually | |
| | uses the service. The subscriber is billed for the service usage | |
| | (payment). | |
| Participant | In a conferencing or collaboration model; there's an inviter (in | The participant may be |
| | this case, the subscriber) and invitees that are authorized to | simply validated (by |
| | participate in the session (scheduled or ad-hoc) | participant code) or |
| | | identified strongly |
| | | depending on the mode |
| | | of invitation and |
| | | requested policy of the |
| | | subscriber. |
| Commune | A group construct that allows creation of custom group of | |
| | participants in a UC conference session—as definable by an | |
| | authorized end-user-subscriber. | |
| CAP | Database Consistency, Availability and Partition-tolerance 3- | It is possible to achieve |
| | tuples; the CAP theorem states at any time only two of them | eventual consistency. |
| | can be guaranteed for a distributed database. | Database designs such |
| | | as HADOOP-based |
| | | Cassandra, Hive and |
| | | HBase claim eventual |
| | | consistency. |
| Instance | Throughout the document this term is used context-sensitively | |
| | to mean a compute-instance or a storage-instance leased from a | |
| | Cloud infrastructure—by reservation (a priori) or on-demand | |
| | (as needed—implying release when the load goes away). | |
| Compute- | An instantiation of a (virtual) machine—typically as a virtual | |
| instance | machine on a hypervisor-driven hardware platform for hosting | |
| | the set of applications and the OS in which it runs. The | |
| | compute-instance's hardware and software configurations can | |
| | be specified per the Cloud provider's menu of options (through | |
| | the IaaS subscriber's administrative console or through | |
| | programmatic interfaces securely. | |
| Storage- | Is usually a raw random access storage instance that could be a | |
| instance | simple type of static size or an elastic instance extendable at | |
| | runtime. Ephemeral storages are local and are born and die with | |
| | the compute-instance. | |
| On-demand | Compute instances that are requisitioned as needed and | |
| | relinquished when no more required. | |
| Pre- | All of the base subsystem configuration for a region is largely | |
| reservation | is by pre-reserving the base size and number of compute- | |
| | instances. | |
| | For every subsystem the unit of reservation is expected to be | |
| | the same size. There are exceptional circumstances when this | |
| | may not be the case that the architecture allows for. | |
| Spot | Spot Instances allow customers to bid on unused Amazon EC2 | |
| instance | capacity and run those instances for as long as their bid exceeds | |
| | the current Spot Price. | |
| Tenant | In the Service Provider hosted model that Akash will deploy in— | |
| | a tenant is any organization in the subscription chain leading | |
| | to the host Service Provider—that assumes responsibility for a | |
| | set of subscribers that are identified by association with that | |
| | controlling tenant's domain. | |

Overview

Cloud-enablement of VaaS implies a distinct differentiation, in principle, from hosted services in the data center. At a minimum, the hosted service in the data-center is close to the VaaS being staged as an IaaS. However, the implied objective of cloud-enablement of VaaS is to leverage existing Public Cloud IaaS infrastructure by shifting towards a software-centric model of the Polycom Core (server-side) solution. This could provide all the benefits of the infrastructure building blocks.

Cloud Definition

The cloud definition is more accurately a description of one example scenario according to different possible embodiments. This definition is followed as terminology-reference for usage in our reference architecture

Core Characteristics of Cloud Computing environment is:

C1 On-demand self-service

C2 Broad network access

C3 Resource pooling (location-independence and pool resources across internet to serve multiple clients)

C4 Elasticity (ability to quickly scale service up and down)

C5 Measured service (control/optimize services based on metering)

Service Models:

S1 SaaS (Software as a Service: applications are served)

a. Use provider's applications over a network

b. User doesn't manage or control the network, servers, OS, storage or applications

S2 PaaS (Platform as a Service: platforms are served up)

a. deploy their applications

b. control their apps

c. don't manage servers, IS, storage

S3 IaaS (infrastructure is served up—leaving platform orchestration to tenant/customer)

a. Rent processing, storage, network capacity, and other fundamental computing resources

b. Consumers gets access to the infrastructure to deploy their stuff

c. Don't manage or control the infrastructure

d. Do manage or control the OS, storage, apps, selected network components

Deployment Models:

D1. Private Cloud (single org; self-managed, hosted or managed; on-premises or off)

D2. Community Cloud (managed by an org or 3^{rd} party; shared by a community of orgs)

D3. Public Cloud (mega-scale infrastructure sold to general public)

D4. Hybrid Cloud (definition of this has several variants; the most official: composition of two or more clouds)

Cloud computing leverages (in many ways made feasible by) the following technologies/added characteristics:

1. Massive scale

2. Homogeneity

3. Virtualization

4. Resilient computing

5. Low cost software

6. Geographic distribution

6. Service orientation

8. Advanced security technologies

Using the Reference Model—Problem Statement

As stated elsewhere, the reference architecture strives for an evolutionary approach from current enterprise architecture. There are elements of the architecture poised for internet-scale, high availability, and conducive to elastic compute and storage capacities. One example that is valuable from elasticity in usage, is the media subsystem—which is compute-intensive by an order of magnitude more than what is available for conventional computing in IaaS. Most IaaS vendors also provide a tier for High-performance-computing (HPC) at their high-end. However, media-plane computing requirements for Advanced Video Coding (AVC) (for transcoding and layout and even trans-rating) fall squarely within the relatively sparse pool of HPC resources in the Cloud. The order of compute-intensity is such that the largest unit of softMCU requires the largest compute-capacity available in Cloud infrastructure today—offering only a capacity of 20 ports at 720p HD. Not all regions of any well-known infrastructure host such a configuration and not in capacities which are required/desired for disclosed embodiments. This is also aggravated by the power-footprint for such a capacity as such a software-based Akash-PaaS package is transferred for operation to a carrier in their datacenter-cloud.

Scaleable Video Coding (SVC) (as opposed to the transcode-layout-trans-rate intensive AVC codec-based technologies) could alleviate some of these limitations—with its three modes of scalability adaptable to various endpoint sizes, bandwidth and resolution needs—that does not impose as much of a compute-burden because it is merely a media-relay function. On a comparative note the same compute-power can yield about 100 high-profile ports or nearly 1000 low-profile (CIF, QCIF) ports.

However, an alternative approach is to take a broader perspective and decide on the optimal course of action as disclosed herein. Architectural realization challenges have several options that may be summarized as follows:

| Core Option | All-EC2 Implication | Hybrid Cloud |
|---|---|---|
| AVC-only | Low port-capacity (10 per 16- | Comparable capacity |
| | core high-end Xeon/i7). | with RMX2000's at |
| | High power-footprint. | lower (by xx %) |
| | Cost per-port is remarkably | power-footprint. |
| | offsetting negatives. | |
| AVC & SVC | Low port-capacity (10 per 16- | |
| | core high-end Xeon/i7). | |
| | High power-footprint. | |
| | Questionable user-experience in | |
| | mixed calls for high-port support | |
| SVC-only | Poor deployed base of endpoints | |
| | Low interoperability with | |
| | existing SVC endpoints | |
| | Impending trend is SVC-based | |
| All-SVC with | This merely transfers the problem | |
| Intelligent | towards the Access: as long as the | |
| Gateways in | interfacing endpoints are | |
| Access | predominantly AVC-centric | |
| | (including VP8). | |

VAAS Reference Model

Video as a Service is a generic term for delivering Video-centric Unified Communications for multimedia collaboration, messaging, content delivery and management and related application enablement interfaces thereof. As a service—implies it can be internet-based. The architectural goal can be internet-scale. The service delivery can be also available on-demand. As such—the compute-intensive media components can leverage the scale of Cloud Computing resources to make Video-centric services available.

Akash Reference Model (FIG. 10)

Akash Reference model is illustrated in FIG. 10 and could be realized in at least two ways.

1. Self-hosted data-center running as an IaaS delivering video-centric UC services at the SaaS layer. The IaaS can be scaled at all subsystem levels in an elastic manner with the media layer the most adaptive and the signaling orchestration layer more HA-intensive and distributed.

2. PaaS hosted on a IaaS cloud such as Amazon Web Services (AWS) or Savvis and delivering video-centric UC services at the SaaS layer.

Akash can leverage evolutions in the following technologies while maintaining the ability to opt for the first approach based on the pace of technology evolution of the following:

1. Ubiquitous SVC support on endpoints (which can be supported in the Akash core)

2. Moore's law as it catches up to make SoftMCU on general purpose processors power-efficient for AVC-transcoding. That said, the cost-per-port advantages that softMCU offers is a distinct business advantage.

3. To a lesser extent—Improved efficiencies of H.265 with improved efficiencies in codecs (with SVC profiles yet to be specified).

Thus, it is feasible to realize, in either case, a packageable PaaS-based VaaS out of Akash for Service Providers to host in their clouds.

The reference model and architecture drives towards the details of each subsystem that shapes such a PaaS. The Akash model depicted in some disclosed embodiments follows the principles of Re-use and extensibility of the existing enterprise architecture. It also focuses on emphasizing logical modules of subsystem modules that deserve specific attention to scaling independently; then as a solution in consonance with each other. To that end FIG. 10 depicts the logical regional instance of a Cloud location. This instantiation replicates at each Cloud location (region) where the VaaS is provisioned. The scale of each region can be determined by the quiescent loads and anticipated dynamic loads as the default watermark.

Akash can be scalable. Akash should require various subsystems of any RealPresence architecture to independently scale and together eventually scale to support millions of ports. However, scale is not only about video (AVC and SVC) but also the ability to support concurrent sessions, provide distributed orchestration of conferences across sites/regions; and also provide the ability to handle SLAs and capacities in a prioritized fashion.

Akash can be highly available. High availability is applicable as much to all the data generated and created—including configuration, log and directory and critical information that has accounting (billing) implications; as well as services themselves; dynamic nature of service instances combined with active-active local configurations with geo-redundant service configurations to ensure constant access to services and user data and meta-data.

The quiescent loads can be derived from the estimated usage projections provided at enrollment phase of a tenant. The estimated usages may be updated by the tenant through the Akash API extensions.

Akash has embodiments that are multi-tenanted. Akash services can be positioned to reach end-users through service providers. Akash services can also be architected to be directly accessible to enterprises, enterprise remote-access and by any invited conference participant on the Internet. Akash embodiments can provide tenant-dedicated resources with guarantees of integrity and virtual isolation from other tenant execution contexts, data and persistent data. In short, service accesses and execution paths can trace what amounts to a virtualized system. The properties of multi-tenancy and requirements are detailed in the various disclosed embodiments.

Akash can provide a rich end-user experience. This general reference model seeks to provide an end-user experience consistent with current endpoint platforms and enhanced to include interworking with mobile and external video service provider solutions through rich web-based interfaces.

Akash can take into account security. Riding on top of security-certified IaaS cloud providers (such as AWS or Savvis) who provide front-end firewall capabilities that are configurable; Akash can supplement these infrastructures with application-level DoS protection capabilities; multi-tenant isolation and with default and high-assurance authentication mechanisms for users (subscribers and invitees to a conference session). Consistent distributed enforcement of configured policies across the logically centralized policy administration framework can assist against theft of service and can provide assured service levels—such as of SLAs for video-quality and bandwidth usage.

Akash can provide APIs to integrate with a plurality of Service Providers' security frameworks. Akash has embodiments with Web-driven interfaces to facilitate exposure of APIs to tenant-admins and, as needed, to subscribers through self-service.

Subsystems Outline

The subsystems of certain embodiments are identified in the following classes

1. Service planes—involving computation, control and communication

2. Access Plane controlling the user, tenant and administrative interfaces to the Akash core.

3. Management planes involving systemic and runtime subsystems

4. Storage and databases involving varied data generation, usage and scale:
a. Subscribers (tenants and end-users), Credential, configuration and policy: applicable to control plane that may be highly available and commonly accessible by all regions in the cloud. This may need to support on the order of millions of user records.
b. Write-intensive such as CDRs, syslog (also used for audit trails and usage analytics). The data may be read-intensive from anywhere on the network but not necessarily real-time-sensitive. Possibly including archival and retention requirements that can vary based on where they are kept (e.g., regulatory compliance) and for whom (tenant requirements).
c. Content-management data. This type of data might benefit from use of caching (such as at the edge of the network using WAN optimizers) when streaming is scheduled. They can also be subject to (offline and online) use for video and audio data analytics. This may be considered truly big-data.
d. All data can be tenancy-sensitive.

5. Application Program Interfaces (APIs). While not a subsystem, APIs pervade as the programmatic gateways to the outside world of subscribers, administrators, tenants and third-party applications developers. A plug-in framework for third party applications to be used by subscribing tenants' can be incorporated into the reference model as well.

Thus, the following subsystems are represented in the reference model.

Management

Akash logically splits the current management subsystem (better known as XMA) into two subsystems—system-management subsystem; and the session-management subsystem.

The system management also has an adjunct extension for Akash—the Akash Resource Manager (ARM) 205. Given the dynamic nature of scaling the media subsystem leading to a compute-intensive pool of media control and media processor elements; the earlier static bridge-virtualization (now part of the orchestration plane) can be stretched to associate ephemeral instances to the media plane. This dynamic nature can be also common to the Orchestration, Access and Session Management subsystems. The ARM adjunct can bridge the system-management-related (monitoring, health, cost and binding) functions with the scaling and on-demand discovery and registration (e.g., into the MCU Resource Broker (MRB) of the DMA). ARM's functions can also include resource-accounting, fault-monitoring and load-balancing among (DMA-) instances and Access Server instances and tenant-configurations.

Directories and Databases

Akash, in a similar manner to XMA & DMA, can use directories of tenants and users. Akash also introduces the notion of groups (or communes) in a community-cloud manifestation where federated accesses to subscribing tenant/enterprise users are mandatory to deliver federation features of participating subscribers. Additionally, external users, sponsored by subscribers may also participate in the Commune with privileges specified by the owning subscriber of the group.

On an internet scale, the magnitude and distribution of user directory cannot easily be met with the use of LDAP-based distributed directories for write-intensive operations. However, usually, the user directories are not write-intensive. It is also impractical to mimic the replicate-all model of directory deployment for a distributed architecture as it leads to O(N²) communication bottleneck. A judicious mix of redundancy-based replication (and HA) with partitioning is used in at least one embodiment. Other analogous approaches based on HADOOP (such as Cassandra) offer alternative scaling alternatives—at the expense of (non-standard) new directory access interfaces away from LDAP/AD. Both solutions offer multi-master replication and both have fault-tolerant characteristics. The latter scales linearly all the way and offers eventual consistency.

Session Plane

Akash architecture's scaling can depend on the scaling of subsystems that it (re-)uses as building blocks. It can also depend on identifying the control plane components reused and addressing the scaling, high-availability and distribution in the context of internet-scale in a Public Cloud. These functions identify the Session (Call & Conference Control & Signaling) plane closely with DMA architecture.

In the enterprise architecture, DMA can perform different roles. Examples include:

1. Call control and signaling plane hosting a SIP proxy and H.323 gatekeeper for example. While call control may not be the default disposition—proxy and gatekeeping can perform the requisite bridging between signaling protocols as well as the conference focus.

2. Managing sessions between the client and conference focus.

3. Virtualizing the bridge resources in units of ports and virtual meeting rooms. The virtualization itself does not constitute the signaling sessions; the bridge-control constitutes signaling (XML/SIP and/or MCCF/SIP) through the MCU resource broker (MRB). This is analogous to the MRB (Media Resource Broker) in the standards.

4. HA management of DMA failures and MCU failures (call-preserving and non-preserving)

5. Identity management—managing dial-plans

6. Bandwidth management (a degree of call-admission control) across deterministically provisioned sites in a controlled enterprise environment.

7. Marginal User management, registration & authentication

8. Geo-Distribution

Media Resource Plane

The media resource can be one of the most compute-intensive and resource-intensive of the services in the entire architecture. It can also be the most network-bandwidth intensive as well in the traffic associated with it. The media compute-resources can be dynamically acquired and released utilizing standard units of computing instances from the IaaS.

Architectural Requirements

General

The set of requirements in this subsection are intended as very high level requirements and are by way of example only.

| | |
|---|---|
| GReq1. | Subsystems can independently qualify to be implemented virtually. |
| Description | All component subsystems can be centOS-compatible. All subsystems—including |
| | media plane components (of MC & MP) are required to use centOS as the |
| | platform. |
| GReq2. | Subsystems can be independently scalable. |
| Description | While this is more of an architectural principle than a requirement - Subsystems |
| | should consider their scaling priorities based on their priority bottlenecks— |
| | computation, network bandwidth, data-access profiles (read/write-intensive; local |
| | or distributed), data-stores (directory, table-driven) or usage thereof. |
| GReq3. | A system instance should scale in a coordinated fashion among subsystems. |
| Description | A system instance is a logical set of subsystems required to specify a completely |
| | featured VaaS solution. This is a qualitative representation of a solution more than |
| | a quantitative specification of subsystem instances. For example, in a deployed |
| | system instance in a cloud, a combination of {single-compute instance of each |
| | subsystem can be deployed together to deliver full Video-conferencing, audio- |
| | conferencing, recording and web-conferencing with chat} provide a full |
| | complement of services envisaged to be offered by VaaS. This set of services |
| | themselves is not bounded. Hence, in a qualitative sense without tending to |
| | attribute too specific an instance-count for each subsystem. Now, one compute- |
| | instance of a Session Manager subsystem itself is capable of handling several |
| | compute-instances (of some capacity—let's say arbitrarily small enough to require |
| | more than at least one instance to saturate any practical limit of handling by a |
| | compute-instance). |
| | Choice of size and scale of each instance of non-singleton subsystem can be |
| | driven primarily ‘bottom-up’ based on the capacity-scaling of the media-plane. |
| | This, in turn, may trigger Orchestration Plane to instantiate a media-plane |
| | instance. |

Media Plane (Media Resource Service)

| | |
|---|---|
| MReq1. | Media codecs: The media plane should support both SVC & AVC modes. |
| Description | [codec profiles for SVC and AVC to be described] |
| MReq2. | Akash orchestration of media-bridge resource can be agnostic to media platform |
| | type—hardware or software. |
| Description | Regardless of the media platform—softMCU, or hardware-based, the port- |
| | virtualization logic can be capable of performing bridge virtualization across both |
| | instance types, in a seamless manner with due visibility into the capacity and |
| | capability of the media server instances. |

Orchestration Plane (Arm Subsystem)

In some embodiments there is a tight relationship between the Akash Session Management (ASM) subsystem and the ARM subsystem. The Session Management is the logical layer responsible for:

1. Call control, if one should be enabled—based on deployment.

2. Conference Control.

3. Call/conference-routing: A distributed conference control can also imply the ability to defer to available conference resources with coordinated ASM instances.

4. Media Resource Brokering:
a. dealing with media server resources that are of varying capacities (larger or smaller instances of compute-resources lead to varying capacities); and
b. mixed, AVC-only

Service Orchestration

| | |
|---|---|
| SOReq1. | Subscriber portal: Akash can provide a web-browser interface to the subscriber |
| Description | The web-portal provides strong authentication to the Akash portal. The Tenant is |
| | the Identity Provider (IdP). |
| SOReq2. | Administrative Portal: Akash can provide a web-browser interface for Akash |
| | administration. |
| Description | The web-portal requires two-factor authentication to the administrative portal |
| | (refer AzReq2). This administrative interface is for regional or cloud-level service |
| | administration by the host-SP. |
| SOReq2. | Administrative Portal: Akash can provide a web-browser interface for Akash |
| | administration. |
| Description | The web-portal requires two-factor authentication to the administrative portal |
| | (refer AzReq2). This administrative interface is for regional or cloud-level service |
| | administration by the host-SP. |

Orchestration: Control & Signaling Plane

Akash Orchestration can be centralized per region. It can be load-balanced across one or more instances of orchestration server. Akash orchestration can also be distributed across regions in a peering manner between the regional orchestrator.

Orchestration functions include but are not limited to:

1. Conference management (including bridge-virtualization);

2. Content management (controlling web-conferencing, content-push, recording, replay);

3. Media Resource Management (of MCUs);

4. Coordinated multi-media management (between video, audio, web-collaboration) data sessions;

5. Coordinating service instantiations, discovery and configuration with Akash Resource Manager (ARM); and

6. APIs for secure integration/exposure of functions to Provider OSS.

Management (System, Call, Scheduling, Presence and Virtualization)

This section describes generic management requirements as well as requirements specific to system management and session management, as examples.

Identity

| | |
|---|---|
| IdReq1. | Tenant Identity is assured by the domain name of the tenant. |
| Description | By the definition of tenant—it is expected that a domain name is associated |
| | with the FQDN identity of the tenant. The tenant may be a MSP, |
| | large social network or Enterprise. |
| IdReq2. | User identity can support PSTN identities (E.164). |
| Description | |
| IdReq3. | User identity can support SIP URIs & RFC822 (email) addresses. |
| Description | |
| IdReq5. | User identity is a tuple of the user name and the associated domain of |
| | identity provider. |
| Description | The identity usually takes on the form of <username>@<domain-of-tenancy> |
| | or username\<tenant-domain>; in general this is consistent with the |
| | direction taken by rtcweb standard. It is also the internet-identity |
| | nomenclature used in authenticating (OpenID) and authorizing (OAUTH) |
| | mechanisms. In any case the username and domain are expected to |
| | uniquely identify the subscriber in the multi-tenanted cloud. |
| IdReq5. | Service instances can be identified uniquely. |
| Description | The instances may be identified in the form used in IMS nomenclature |
| | <instnum>.<inst-type>.[tenant.]akash.com |

Directory Services

| | |
|---|---|
| DS1. | Akash should maintain a tenant directory |
| Description | An Akash-wide common directory of tenants can be supported. The directory |
| | entry includes attributes including but not limited to: |
| | 1. Domain name |
| | 2. PoP (Regions allowing entry into Akash) |
| | 3. Remote PoP (points of invocation of tenants to inventory enrolled tenant- |
| | PoPs) |
| | 4. Base number of subscribers |
| | 5. Number of concurrent active subscribers |
| | 6. Roles of subscribers (based on CoS) |
| DS2. | Multi-tenancy support for tenant directories should allow for partitioned |
| | directories. |
| Description | User and, as applicable, device directory for a tenant should be isolated. In default |
| | cases where they are |
| DS3. | Management Interface API should support CRUD of users by tenant |
| | administrator. |
| Description | Administrative roles for add/del/update of users can be allowed to for tenant |
| | administrators. |
| | The user roles should include (a) tenant-admin (b) auditor (c) subscriber (d) guest. |
| DS4. | Support specifying class of service (e.g., gold, silver, bronze) for subscriber. |
| Description | The subscriber class should be described by attributes based on pricing or usage. |

Application Enablement (User Portal)—APIS

Akash Portal can have a common web portal for all users. Akash portal can also include Signaling, Media Access gateways into Akash Services. In addition, value-added applications may expose services through API interfaces. The interfaces can be RESTful. Some modes of the interfaces may also need to support sending notifications to clients—requiring persistence through http-long-polling or websockets. The transport selection could be between Bayeux (Comet) and websocket with JSON data format.

The capabilities of a Portal include the set of server portlets that handle requests at

1. Web-portal: the web-interface

2. Signaling portal: SIP B2BUA, H.323 GateKeeper, rtcweb interfaces of Akash Access plane.

3. Media Portal: The media flow that ensues when a point-point or multipoint; and

4. Application Portal: It also includes, depending on configuration, application gateways such as XMPP (for Presence, chat/IM and possibly as shared portal for Vivu-interworking) gateway; rtcweb service and gateway (to SIP backend and SIP client peers) and, where relevant.

| | |
|---|---|
| API01. | Akash can support a web-based client to invoke a SIP-based AV client. |
| Description | The SIP-based client could be a plug-in or a platform-resident peer application |
| | (e.g., a m100) that accepts required modes and parameters programmatically and |
| | initiates a session with its domain call server; and in turn sets up a request with |
| | the Akash video feature server. |
| API01. | Web-client can support HTML5—including for web video and audio. |
| Description | Web support for two-way video HTML5 API is evolving. However, HTML5 is |
| | set to supersede Flash as the multimedia standard. |

Security & Privacy

| | |
|---|---|
| SecReq1. | Network Security: appropriate firewall settings should be started with secure- |
| | by-default. |
| Description | Secure-by-default implies initial default configuration of denying all accesses |
| | to resources. Permissions are later enabled |
| SecReq1. | Internet exposure: Externally addressable instances should be confined to the |
| | access elements. |
| Description | Security best-practices pertaining to an enterprise-style deployment are to be |
| | adhered to. |

Confidentiality & Integrity

| | |
|---|---|
| CIReq1. | All inter-instance communication should be protected by channel message |
| | integrity protection. |
| Description | It is assumed the message integrity algorithm appropriate to the protocol used can |
| | be applied. The minimum can be SHA-1 (160). |
| CIReq2. | All inter-instance communication should be protected by channel encryption |
| Description | It is assumed the encryption algorithm appropriate to the protocol used can be |
| | applied. The minimum can be AES-128 bit mode. |
| CIReq2. | All end-end media and signaling should default be secured—for confidentiality |
| | and integrity. |
| Description | Signaling protocols: SIP-based can be using SIP/TLS or SIPS. |
| Rationale | Akash assumes all communication from clients to its services to be over internet |
| | regardless of the protected nature of a Provider-based deployment model. |
| Comments | |

Authentication

| | |
|---|---|
| AuthReq1. | Akash should continue to support current authentication mechanisms based on the |
| | signaling path (H.225.0 RAS or SIP REGISTER). |
| Description | Akash can be configured to not allow, however, an unauthenticated conference |
| | entry by organizer or participant. It can require a participant passcode distinct |
| | from the organizer's. |
| AuthReq2. | Web-based authentication of subscribers at tenant-portal should authorize Akash |
| | portal to deliver service(s). |
| Description | A browser-based interface through any personal device (laptop, tablet,) initiates |
| | video-service access with Akash web-portal; authenticated by subscriber's |
| | provider; which authorizes the subscriber's access request to Akash portal. Akash |
| | portal responds with appropriate presentation of menu of application choices as |
| | determined by subscriber's configured options at Akash portal. This uses either |
| | OAUTH or OpenID or SAML-SSO authorization tokens. |

Access Control & Authorization

| | |
|---|---|
| AZReq1. | Role-based Access Control for Administrative and VaaS service subscription can |
| | be supported. |
| Description | Administrative roles will need to be supported. User identities for audit trails may |
| | be optionally asserted in the provider-context for recording at the VaaS end. |
| AZReq2. | Akash Administrative Access Control can require two-factor authentication. |
| Description | This requires explicit user-identification with user-digital certificates to establish |
| | administrative access to mission-critical administrative resources. |
| AZReq3. | User-access may also be supported under RBAC. |
| Description | (as described under AzReq1) |

Authentication

The Akash model can include a two-tier access to the end-organization (e.g., an enterprise) through a Service Provider—as the default model. However, it does not preclude the ability to deliver cloud-brokering services to businesses (hosted) federation (B2B) and individual users (B2C).

Tenant Authentication

The tenant model itself allows for multiple tenant organizations. The tenant organizations can be identified by their domain names. The administrative APIs can be subject to authorization based on this authentication. However, the trust model for the tenant can be based on the secure session established using M-TLS credentials.

Authorization & Access Control

Authorization to access Akash resources and related Access Controls can be part of the Akash Security & Policy Framework. All policies—security, authorization and others at a subscriber-granularity can be enforced based on tenant-scope. Akash-level tenant policies can also be enforced above tenant-level scope (Akash-scope).

Multi-Tenancy

Multi-tenancy in one embodiment of Akash follows a hosted solution provider model. Akash can limit the tenancy-awareness to subsystems on a need-to-know basis: most of the modules are not required to explicitly identify or distinguish tenancy when they perform feature & service functions at granularity and scope of a tenant. For example, Media plane is largely dedicated to performing media operations. While it needs to ensure isolation between its resource-partitions such as memory and local temporary stores that log, CDR and content-stores (in the event of recording); these are easily kept transparent to the media-layer if the right references are set up at the higher control and orchestration layers. Hence, it is the Access, Application Enablement (App Services) and Session Management planes that should have partial or full exposure to multi-tenancy with tenancy-awareness and enforcement.

Multi-Tenancy Architecture

An architecture handling multi-tenancy, in one embodiment, consists of

1. Tenancy-Resolution Interface at the system's Client-Access points (portal).

a. Tenancy-Resolver

The tenancy resolver can use the identity of/associated the incoming user/client request to resolve the tenant with whom the entity (user/client/subscriber as may be differently known) is associated. An invocation context can only associate an entity with one tenant. What is more, if the invocation is associated with a session, the session is associated with only one tenant at any instance. Dynamic (mid-stream) switching of tenant-affiliation may be accommodated (but discouraged). If the entity wishes to change tenancy-affiliation—it may do so in the context of another tenant—possibly using a different affiliation.

b. Tenancy-Mapper

Once tenancy is resolved (tenant identified) the invocation context can be mapped to resources referencing

2. A set of single-tenant subsystems. Each subsystem can take two different forms depending on whether the multi-tenancy is fine-grained or coarse-grained.

Multi-Tenancy Model: Options

This document describes two example models for multi-tenancy. One is a fine-grained model and the other is a coarse-grained model. The latter is a well-suited model for static enterprise configurations.

Fine-Grained Multi-Tenancy

In fine-grained multi-tenancy (F-MT)—each core subsystem is required to be multi-tenant-aware (MT-aware). The tenancy-resolver is out of scope. However, the tenancy mapper is in scope at the subsystem interface (invocation entry-point).

Coarse-Grained Multi-Tenancy

In this case (C-MT), both the resolver and mapper are out of scope. This facilitates and implies that each subsystem instance be nailed to a tenant by some out of band mechanism at the point of instantiation. For relatively long-lived instances this is not an issue.

There are several classes of regulatory constraints to be considered. Regional regulatory constraints are one class that is compliance-related. Regulatory requirements related to vertical segments (healthcare-HIPAA, GLBA—finance sector, SOX—corporate) are interpreted by corresponding technical standards (such as Hi-Tech) that indicate or imply tenancy-related physical and logical access control of runtime objects and stable-stores (user and tenancy-level databases and directories).

Application Enablement (and APIS)

The modes of Akash service orchestrations can include web-portal based meet-me services can be a prominent one. Conventional interfaces not requiring changes to the current user experience can also be part of such orchestration.

Service Provider Interfaces

APIs meant for SPs are implied to be used for Operational support (OSS) and Billing Support (BSS) services. The (RESTful) interfaces are also used to expose service-requests for scheduling and initiating sessions (3^{rd} party call control).

1. Existing API context is assumed to enable inference of tenant identity through the invocation context. The tenant can be fully qualified by the domain of access and the role/identity of access (as determined at the time of session-establishment). The role/identity can be specified as part of the asserted identity in the http(s) authorization header of the API invocation. Thus, it is not necessary for the APIs to be made tenancy-aware if the above requirements are met. In the case of SIP session dialogs, the identity/role can be specified in the PAI header. (when interfacing to an IMS architecture, the ICID—IMS charging identifier—may be used as well)

2. A super-administrator (across all tenants) role for the Cloud can be included. The role authorization can be administrative and not have read-visibility into the tenants' user-data or content—among other capabilities and constraints.

Reference Architecture

This reference architecture chapter itself delves into details of each subsystem identified in the reference model.

1. independently and together scaleable;

2. interactions and dependencies between the instances and how the current limitations of the enterprise-architecture are resolved;

3. as well as how the IaaS can be and is used in well-known Cloud configurations such as EC2.
a. For example, feasibility of using S3 CloudFront and noSQL in place of current postgreSQL for CDRs and logs
b. Use of Cassandra or other linearly scaling multi-master highly-available HADOOP database constructs already present to be used for scaling the rest of the stack besides addressing media plane scaling.

The architecture can allow a hybrid approach using a dedicated data-center to host the media-cloud component as well as hybridizing customers' enterprise deployments to seamlessly overflow usage into the utility-based video service.

Reference Model

The reference model has been separately discussed above. It sets the context for the reference architecture details.

With reference to FIG. 10, a plurality of individual reference models could each represent a node in a multi-nodal implementation. Although the nodal representations may seem identical they are not required to be. Nor are configurations required to be identical for subsystems. For example, a CDR-database instance in Node 1 may be shared between itself and Node 2 in the same region A. This database may be replicated elsewhere other than region B. Any given region may have just one node and lower load.

The notion of a Cloud Node implies having the same geographic region being served by two physical cloud datacenters. This is derived from the definition of nodes in AWS (e.g., Amazon Web Services and EC2 Elastic Computing Cloud).

Multi-Tenancy

Akash can support multiple TENANTS—who are bulk-subscribers of VaaS resources. The tenants' subscribers may themselves require tenant-specific isolation of their services' resources (e.g., Coke and Pepsi) for reasons of confidentiality, SLA and strict-partitioning. Strict partitioning may be required by customers who have a need to ensure physical isolation of resources (data and sometimes even runtime logic) to achieve isolation from other tenants' data and runtime contexts. The tenancy considerations can be important when providers are nested. Akash, in one embodiment, uses a simple flattened tenancy model based on being able to identify each first-level Service Provider customer as a tenant. There can also be additional levels of tenancy—the notion of a sub-tenant.

When the tenant establishes a RESTful API session and/or SIP session with the Akash web Portal and/or Akash SIP Portal respectively; Akash session manager (ASM) can get updated with the context of the session and hence binds the domain information with the tenant. Akash Access Services (AAS), Akash Application Enablement Services (AAES) and ASM are sensitized to enable tenant-specific policies to the session and applications.

Scalability

As mentioned earlier, the Reference architecture allows for realizing the Cloud as a datacenter-based build-out based on proprietary systems. This calls for building support structure for elasticity and scaling. The gain is in computation capacity with existing hardware accelerated systems.

Rather than taking the datacenter approach to building out using existing Cloud IaaS to build out a Platform framework to realize Akash; packaging and potentially leveraging the IaaS ecosystem (for databases and related scalable resources at the lower level) as well as achieving elasticity is facilitated.

There is a hybrid approach that Akash allows for. This hybrid approach is described below after the following discussion for an IaaS-based approach:

There are many considerations to system scaling in the Cloud. Among them are the three Cs—control, computation and communication.

1. Computation
a. Not a matter of Moore's law performance alone
b. As the unit of scale approaches the largest unit of compute-instance (such as 8 cores), theoretical limitations of symmetric multiprocessing are reached. Non-conventional architectures such as NUMA are introduced (leading to tightly coupled clusters).

In the media plane, a choice of lower configuration compute-instanced increases the number of instances to support the same capacity. This leads to greater complexity and overheads in cascading and inter-instance coordination with mid-to-large conferences. In some conditions such communication can become a bottleneck (control and communication complexities traded for compute simplicity)

2. Communication
a. Network Bandwidth
b. Locality of reference; remote references are limited by the limitations of pipe width between regions

Bandwidth management is centralized in ARM. Available bandwidth

1. between a site and its associated regions; and

2. for incoming requests and the requested data-rates can be assessed under the Media Request Broker. All bandwidth reservations and releases can be coordinated and performed by forwarding the requests to the ARM that manages available bandwidth requests through its control interfaces with the IaaS infrastructure (APIs).

3. Control
a. The cascading control required to scale large conference sessions and possibly between sites when multiple sites are involved.

4. Storage for structured data Logs, CDRs, content-stores for recording and replay; are all big-data problems with widely varying write- and read-contexts and data-chunks. Moreover, the distributed nature, sensitivity and high-availability requirements of such massive volume of data has to be balanced with linear scaling requirements.

While the architecture and design needs are massive internet-scale in volume, distributed nature of operations and high-availability and consistency of data; the architecture also has to deal with dynamic nature of allocating processing resources to optimize cost and power of compute-resources that can change by orders of magnitude in a 24-hour cycle.

Hybrid Approach and Scaling

The hybrid approach proposes the media-plane subsystem (which is the prime candidate for compute-scaling) to be data-center-hosted. This allows staging of the media-plane to be isolated into a custom-cloud while continuing to leverage standard IaaS infrastructure for Access, Control, Signaling and Management.

Database

Data-generation can be highly localized but accessed from anywhere worldwide for searches, queries and analytics. These read operations could be in real-time or non-real-time, depending upon the nature of the application. The write operations, even if not real-time sensitive per se; are often performed in-line with real-time operations and are usually expensive when considering that traditional write-commits to stable-stores as needed for CDRs can be relatively time-consuming.

| | | | Content | |
|---|---|---|---|---|
| Content-type | Logs | CDR | (A/V/data) | Directory |
| High- | Local redundancy | Required: Geo- | Optional—based | Can be highly |
| Availability | may suffice. | redundancy a | on SLA. | available and |
| | | must? | | anywhere |
| | | | | accessible. |
| Read-efficiency | | Non-real-time | Near Non-real- | High read- |
| | | reads; | time; can be | efficiency is |
| | | distributed— | accessed from | required from |
| | | spans across | anywhere; | anywhere in the |
| | | regions | streaming in | internet (cross- |
| | | | nature and can be | regional). Can be |
| | | | mitigated by | commensurate |
| | | | WAN | with network |
| | | | optimization & | latencies. |
| | | | Caching (e.g., | |
| | | | Akamai) | |
| Scalability | Largely localized | Must linearly | | Must scale |
| | for writes; should | scale writes; | | linearly with |
| | linearly scale. | should linearly | | additional |
| | | scale with | | capacity (more |
| | | capacity. | | machines added). |
| | | | | should |
| | | | | accommodate |
| | | | | adding capacities |
| | | | | without requiring |
| | | | | stoppage of |
| | | | | systems. |
| Write-efficiency | | Real-time | Usually localized | While writes can |
| | | writes-usually | when recording | be from |
| | | localized to | | anywhere; |
| | | region | | normal latencies |
| | | | | are sufficient. |
| Multi-tenancy | Yes-required. | Required. | More than merely | |
| | | | tenant-specific. | |
| | | | Subscriber- | |
| | | | specific as well— | |
| | | | when recorded. | |
| sensitivity | Must avoid/ | Must avoid/ | All recorded | User credentials |
| | encrypt PCI/PII | encrypt PCI/PII | content is | are sensitive and |
| | data. | data. | privileged private | hence are a |
| | | | data of the | consideration for |
| | | | subscriber/tenant | storing them in |
| | | | and can be stored | high-assurance |
| | | | encrypted. Upon | data-centers off- |
| | | | removal of | cloud. |
| | | | content, the | |
| | | | content store | |
| | | | should facilitate | |
| | | | scrubbing of the | |
| | | | stored area. | |
| Regulatory | Generally not | Generally not | Sensitive to | |
| (e.g., CALEA) | applicable. | applicable. | storage and | |
| | | | regional laws. | |
| E911 (specific | Relevant. | Relevant. | Relevant. | Not relevant |
| to first- | | | | |
| responder | | | | |
| tenant) | | | | |
| Analytics | Candidates for | Candidates for | Absolutely | |
| (these have | diagnostic, | usage and | necessary for | |
| implications of | performance and | tenant-specific | application level | |
| highly scalable | usage analytics | analytics | analytics of | |
| cross-region | | | content for | |
| read-accesses; | | | tagging face- | |
| while the | | | recognition (all | |
| databases are | | | off-line) | |
| still online and | | | | |
| updated). | | | | |
| Write- | | | | |
| coherency | | | | |
| Consistency | | | | |
| Partition | | | | |
| Tolerance | | | | |

Records—Log, CDR

At system runtime, in the context of a session (before during and after) logs (syslogs and other), session-related ephemeral information and CDRs can be generated and written to persistent store for later review, audit and accounting: these write operations can be write-intensive of in-line with real-time sessions. The volume of information available for use can be massive—even within a tenant; in a distributed architecture, session data may be concurrently written by several writers and needs to be subject to easy collation and tagging (for later analytics and earlier mentioned purposes). Moreover, the database needs to be conducive for multi-tenancy (logical partitioning and isolation) of data.

Such a database needs to be

1. High availability

2. The scale of data to be analyzed or made available for view-queries online could require linear scalability.

3. The databases could to be partition-tolerant. Network outages can cause database partitions to be isolated. However, partition splits in a distributed database can be tolerated and guarantee data integrity and eventually when the partitioning is mended—should be able to achieve consistency.

4. The databases should able to deal with the instances becoming inconsistent albeit temporarily. However, ideally they need to be eventually consistent.

Content—Multimedia

In principle, multi-media content store may be provided by the tenant or subscriber. Akash interfaces recording multi-media content to appropriately configured tenant-specified stores. Akash also supports a framework based on the resident IaaS to record and replay content. In doing the replay—Akash may use SaaS services available as part of the IaaS (such as WMA or Wowza) through a framework leveraging ViVu and Accordent.

Content storage management is also subject to regulatory compliance of the region of storage, origins of recording and the privileges entitled to the accountable subscribers/tenants. Such content can be securely accessible to the subscriber who has paid for the recording and retrieval service and can be stored encrypted using keys exclusive to the subscribers and their sessions.

Directory (FIG. 12)

Akash can maintain a directory of tenants as shown in FIG. 12 element 1200. The tenant may be a large enterprise or a Managed Services Provider the VaaS services for which are hosted in Akash. Akash can also host, a user-directory with a minimal profile required to deliver the set of services required. For richer set of services—additional user-information may be sought (such as notifying the user by email). All directories can be multi-tenancy-sensitive. The tenant-directory should be private to Akash. Communes can be formed by a service-enabled subscriber. A group directory can maintain the details of each commune.

Users

A UC-centric video application can be made to remain user-agnostic and be made to be visible as a virtual resource (e.g., a virtual meeting room) to be used. However, when fine-grained authorization is sought to share such a subscribed resource, validating the participant requires some degree of exposure of the identity of the client. This may be in the form of a restrictive role or group. This is usually sufficient for coarse-grained service-authorizations and control to ensure certified usage.

When user identity is fully specified—a richer set of access controls that are personalized can be provided. More importantly, a richer set of services can be enabled—while still preserving user privacy. This can be achieved without having to expose to Akash enterprise-sensitive, tenant-sensitive or subscriber-sensitive (such as PI and PII) confidential information.

One approach to manage users is through Cloud-brokered virtual directory services See FIG. 12. Organizations inclined towards a hosted model for subscriber contact information may host the subscriber information in Akash. Thus, it is possible to realize a hybrid virtual directory 1205 of hosted subscriber database and virtual subscriber database. With the virtual component—there's an implication of interoperable interfaces and gateways needed to retrieve contact information from the tenant (MSP or enterprise). Hence, a virtual directory component extends resident support at the enterprise/tenant. The enterprise Access Server (e.g., feature-extended SAM) with due access to enterprise directory can provide the assurance of controlled sharing of contact information for richer Akash service features requiring user-identities and relevant characteristics.

Tenant

The tenant may be a large enterprise or a Managed Services Provider the VaaS services for which can be hosted in Akash. A tenant is usually multi-site and multi-regional. Akash allows the sites of a tenant to home based on the region.

Group (Commune)

Akash can manifest as a community cloud as much as it is a public cloud. In a community cloud, its characteristics of being a Federation Broker in the Cloud can be important. However, all properties that enable such a role should also be available in the Public Cloud configuration.

The subscriber can populate the commune with Group directory access is privy to the subset of subscriber-tenants in the group configured and administered by the group-sponsoring subscriber (this can be done through restricted tenant-administration interfaces). The group-participants can have limited administration.

A Commune is a virtual group. It can be created by a user subscribing to this feature. The user can define the purpose of the Commune using primitives definable in terms of Commune Objects and Activities. Commune objects can be other communes, participants and resources. An example resource is a content store for the Commune (with spatial limits). Another example is the maximum usable bandwidth for the Commune (which the Akash Session Director may use in conjunction with ARM for allocating media resources and bandwidth management). Activities can be services that the Commune can use—video, audio-only, whiteboarding, web-conferencing, recording and playback. Access Control, QoS and other policies frame the scope of the Commune.

These help define the scope of activity-control on the aforementioned services. The

Commune may be configured to auto-expire (with archival etc.) or manually removed by the Creator. Other capabilities and policies are definable within such a framework.

Capacity

Akash Access Services

Akash Access Service (AAS) is the gateway to the Akash VaaS Cloud Services. AAS can be responsible for Akash and Tenant firewall settings.

Akash can be DNS-load-balanced over its set of firewalls. The number of such entry points are driven by the estimated network bandwidth requirements of incoming tenant traffic. The Akash web-portals and SIP-portals can be independently load-balanced using HTTP-redirect and RFC3263 standards respectively. XMPP has its load-balancing mechanism built into the standard. The schematic layering of AAS is depicted as in FIG. 13.

FIG. 14 compares the generic Secure Access Manager (SAM) component architecture with that of the Access Services Plane meant for Polycom Cloud architecture. See also FIGS. 15-16.

Polycom Cloud Access Plane serves as the application layer gateway to signaling, media and web services. It also serves to accommodate application gateways to UC services for interworking with and federating with XMPP-based applications. Other UC applications that require adaptation of call-flows for standard protocols and extensions thereof such as TIP, RTV, Lync application and RDP are also acceptable. The Access Plane also will serve as rtcweb webserver to rtcweb clients routing and relaying incoming JSEP requests (over https) to appropriate destinations, if needed, serving as SIP gateway to non-rtcweb destinations.

Akash System Management Services

The system management part is responsible for session-independent activities such as configuration, provisioning and installation management of core, endpoints, tenants and users. Session management deals with session-specific management of resources and users (and to some extent device endpoints). With at least one exception of bridging the two and isolated from this abstracted enterprise architecture is ARM—which addresses Cloud-specific on-demand resources which may also be relevant to Private Clouds as well.

The RealPresence architecture has five identifiable logical subsystem services

a. the media

b. session management

c. application services

d. access and

e. system management.

The system management service centralizes the individual element management through internal RESTful APIs. System Management service can be responsible for FCAPS management all subsystem elements (and instances thereof). RealPresence System Management Service (RPSMS) also unifies user management for an Akash cloud (cross-regional). RPSMS can incorporate and orchestrate the elements of multi-tenancy by adding support for Tenant Management. Tenant Management involves providing a logical (and where demanded by a tenant, physical) separation of tenant-specific resources such as tenant-subscribers, tenant and its subscribers' policies and service-levels as well as usage related data.

Akash Application Services (RPUCS)

The Real-Presence Application Services (UC services) include, beside conferencing related services (such as scheduling and calendaring), content-sharing (in a video-conferencing session), MODERATE (XMPP-based) Presence, conference recording service and hardware-based white-boarding. True Collaboration services that offer some of the above features with enhanced traits such as persistence will deal with centralized content-management, associated high availability and other richer trait and feature integration. RPUCS plane will also host application services. The RPUCS capabilities will include session, media or both services for live media and content manipulation and offline media analysis and usage (such as playback, streaming and analytics). Other services can include web-conferencing and webcasting: which includes dealing with additional media of data—textual (chat) and/or graphical (slideshow and white-boarding).

Akash Session Management (RPSM)

This section describes the Akash Session Manager—more generically the RealPresence Session Manager. The reference model combines session management functions together while retaining the context of a UC session—especially the state of signaling session—call control if and when it is used; and conference-control of sessions.

ASM interfaces with Access instances including authentication backends for web-portal and signaling path. Signaling path gates through the SBC where the SBC serves as an ICE gateway as well as a B2BUA (SIP) and H.260.18 gateway for H.323 signaling.

RPSM Media-Resource Brokering (RPSM MRB)

While not exactly a part of session management; this feature provides a means of handling conference placement among elements of media pool (identifying the best fit media unit for a conference size), media resource-brokering and conference placement & bridge virtualization. The media resource broker interactions may extend to the Application Services plane. The purpose of MRB is multiple in general and involves possessing the intelligence to identify the right size and type of media resource for an service request—including dealing with multiple vendor-equipment.

In the Cloud architecture context—considerations such as multiple vendor-types are least relevant (if not non-existent) and MRB offers a powerful tool to arbitrate between independent instances of service requests, media resources and the RPSM conference instances. A distributed manifestation of MRB inside RPSM conference instances (constituting the RPSM subsystem)

Akash Media Resource Service (Control & Processor)

Media plane presents a potential to leverage elasticity of cloud and on-demand compute-resources. See FIG. 17. The reference model presents the media plane components and the protocols and API interactions between the higher-level control and the ITU-style media-control (MC) layer in the media plane that allows MC to scale independently of Processor scaling that can scale variedly depending on the quality and mode of the codec and processing involved (transcoding, transrate, layout of AVC) vs. simple media relay and trans-rating of SVC.

Akash Resource Manager (ARM)

As a dynamically self-reconfiguring and scaling system geo-distributed strategically across several regions (for load-balancing, geo-redundancy and scaling purposes) an orchestration and management subsystem, Akash Resource Manager, is responsible for managing and delegating resource-instantiations, monitoring instance-health, IaaS capacity thresholds, and adjusting thresholds for pre-reservation and on-demand acquisition of compute-instances. ARM is also implicitly responsible for identifying the appropriate policies to be in place for the instances and addressing overall glue logic requirements to facilitate such dynamic instances become part of Akash. See FIG. 2.

Introduction

The primary resources in the Polycom Cloud Architecture can be organized hierarchically into:

1. Provisioning/management—i.e., the master intelligence controlling and coordinating the overall service

2. Control/Signaling—e.g. DMA equivalent, aka Application Server, including Resource Broker

3. Media Handling—e.g., MCUs (RMX, MRM, soft-MCU, Universal Media Server), RSS, web portal(?)

4. Persistent storage and databases

Any of the components above could be a “hardware-based” resource (e.g., traditional RMX, DMA, or RSS) or a dynamically instantiated “software-based” instance.

General Principles

Each subsystem has domain-specific knowledge of its resource usage and other instantaneous dispositions. In the elastic environment, each subsystem is to be considered to have more than one instance to work with to facilitate elastic load. This can be incorporated into the design of each subsystem. Thus, the totality of resource-usage and runtime profile of a subsystem is the cumulative logical profile of each element (instance) of that subsystem. An instance is created or destroyed based on the policies governing its subsystem or as dictated by tenancy or by other policies outside the scope of the subsystem's domain-knowledge.

Resource Manager

All scalable resources and instances can be tracked by an entity known as the Resource Manager. The Resource Manager can be aware of all availability and usage for a particular type of instance within a particular domain, typically a tenant or sub-tenant or subscriber/customer client of the service instance. It will understand the details of how and where the resources under its control are utilized. The Resource Manager will closely track the capacity, utilization, and availability of applicable resources in its domain. As resource-affecting events are processed (e.g., call up, call down, instance failure, instance availability), it will take appropriate actions such as distributing load, allocating or deallocating instances, or coordinating redundant switchover between a failed instance and an available standby.

Interfaces: Resource Manager has a southbound interface to the individual hardware and software resource instances that it directly manages and a northbound interface to its co-resident or otherwise assigned Resource Allocator.

Resource Allocator

The resource allocator is an entity that is responsible for managing and “distributing” dynamic and scalable resources at a higher level than the Resource Manager. It handles requests from individual domain-specific Resource Managers to allocate and deallocate resource instances, and handles those requests by making assignments from existing instantiated software or hardware resources. If insufficient resources are currently available to fulfill a certain request, the Resource Allocator can attempt to fulfill the demand by launching new dynamic instances on private or public “cloud” infrastructure or requesting resources from another organization or domain. It will track which entities have been assigned resources for purposes of billing and tracking, as well as enforcing limitations placed on instance usage at the various applicable administrative levels.

Because instances and resources often take finite time to launch and initialize, and it may be economically or administratively inefficient to potentially shut down and relaunch an instance immediately rather than having had kept it in service, the Resource Allocator can be configured to keep a “ready pool” of resources instances available at all times so allocation requests can be met in real-time and deallocation requests don't necessarily immediately destroy the instance (for example by keeping it around for potential reuse until the time period that was already paid for is used up).

Interfaces: Resource Allocator has a southbound interface to one or more local Resource Managers and/or subordinate/client Resource Allocators, and an optional northbound interface to one or more Resource Allocators to which it is a client. The Resource Allocator may also support special/proprietary northbound interfaces for creating elastic software instances, such as AWS APIs for creating and managing EC2 instances.

Multi-Tenancy

MRBs will serve a particular organization and domain. Typically these domains can be organized hierarchically (e.g. subscriber->sub-tenant->tenant->service provider), but the Akash resource sharing architecture will not assume or mandate this. Each Resource Allocator instance can be provisioned as to which other domains it will request resources from and/or provide resources to, and the limits to which it is willing to “borrow” and “lend” over time and at any point in time.

Assumption: the “master” Resource Allocator of cloud-based software resources will typically operate at the service instance level on behalf of all tenants. This could provide efficient pooling and operation of resources. When an instance or other resource is no longer needed by a particular tenant, it should be returned to the master pool, where ideally in can be efficiently re-initialized without restarting or rebooting the instance. However, the model should also support hardware and software instances that are dedicated to a single tenant “leaf” or “branch” in the hierarchy.

Agent-Broker Model

Each instance in a given subsystem provides stateful information about its resource-usage and disposition (health, type and other)

Resource Management APIS

This is an abbreviated version of ARM APIs that subsystem agents invoke to requisition instantiation and de-instantiation of its unit of operation. The agent is subsystem-specific and serves as a singleton

a. SubsysInit(InstType InstTypeList[ ])/* initialize the subsystem for */

InstType is an object describing the instance. Each instance type describes one or more sub-subsystems that may scale independently itself. Usually this is just one instance-type. Each subsystem may also choose to model with an agent for each sub-subsystem in which case the InstTypeList[ ] has a size of one.

```
InstType {
  StartInst; // initial number of instances to invoke. This may be
  overridden by ARM itself based
        // on guidance from system configuration management base for
  that region.
  MaxInst; /* initialized number of maximum instances */
  InstObj InstSize; /* feeds, speed, core, memory */
  . . .
}
```

b. InstAdd(InstType, numInst, attributes, &InstIDs[ ], InstCallback)/* */

c. InstDel(InstID)/* */

d. InstSuspend(InstID)/*Suspend an instance. The client agent makes a decision, as part of the subsystem, to not give up an instance but suspend for reasons such as in anticipation of repurposing for another tenant context or other subsystem-specific reasons */

e. InstResume(InstID, Ctxt context)/* */

ARM can be implemented somewhat outside the scope of subsystems. That implementation will provide core libraries for the agent-common primitives (including stubs) and may use RMI or http-based RESTful APIs. However, the requests can be asynchronously served. Notifications/responses will ensue asynchronously. The instances themselves can have callbacks into the singleton agent to send notifications of resources used and released to provide capability for the subsystem to consolidate (a la garbage collection).

### Example

British Telecom (BT) deploys and operates a hosted RealPresence Core Service based on the Polycom Akash framework. The service is resold by Demon Internet (a tenant of BT) to Lloyds of London (the service customer).

1. An end-user at Lloyds dials a VMR number to create an ad-hoc conference

2. A hardware-based DMA cluster owned and operated by Lloyds acts as the MRB for their organization. It manages a pool of local RMX2000s but is configured to burst for additional capacity to Demon Internet. In this example, none of Lloyd's RMXes have sufficient capacity to host the new conference, as determined by the DMA cluster's Resource Manager, so it requests additional resources from the local Resource Allocator, also running on the DMA. The local Resource Allocator has not been enabled with the ability to dynamically create new MCU instances itself, so it makes a request to the Resource Allocator of Demon Internet.

3. In this example, Demon Internet also maintains a pool of locally owned and operated hardware RMXes in its datacenter, but in our example these have already been leased/loaned to other customers. The Demon Internet Resource Allocator, a soft-DMA cluster hosted in the Demon data center, thus forwards the request to the BT Resource Allocator.

4. The BT Resource Allocator has the ability to dynamically create new software-based MCU instances, either by creating new VMs in the BT datacenter (private cloud) or using Amazon Web Services APIs to create soft-MCU instances hosted on EC2 (public cloud). In this case, it allocates an EC2 instance from its ready pool and returns it to Demon Internet and ultimately Lloyds. The Resource Allocator can be configured to track and charge the soft-MCU instance usage to Demon Internet or all the way back to Lloyds.

5. The (DMA-hosted) Lloyd's Resource Allocator receives notification of the allocated resource and “returns” the cloud-based soft-MCU instance to the local Resource Manager, which configures it appropriately for Lloyds usage and places it into service, routing the media streams for the initiating call and any other calls that are to join the current ad-hoc conference.

6. The soft-MCU instance is now indefinitely under control of the Lloyd's DMA Resource Manager, and may be used for other any other calls/conferences as Lloyds deems appropriate.

7. If the instance becomes idle, the Lloyds Resource Manager can return it back to the local Resource Allocator, where it can be maintained in a local ready pool or returned back to Demon or ultimately to BT. If the BT Resource Manager determines it is no longer needed, it can destroy the Amazon EC2 instance or local VM.

Network Configuration

Placing dynamic instances in the correct (private) sub-network, naming instances and referencing them in a common naming service (either an internal DDNS of ARM or through WSDL yellow-pages). This facilitates lookup by services and instances. For example, the media bridge-virtualization will reference media-instances by their distinguished names, viz.,:

<instance>.<service>.<site>.<region>.akash.

The MC instances will reference MP instances likewise over the network.

Portals

Akash exposes rich web interfaces securely through both GUI over a web-server portal; as well as programmatically through RESTful web-service interfaces (APIs). Such interfaces can be broadly classified as Administrative portals and end-user (subscriber) portals. In turn, the administrative portals are for the administration of Akash Solution itself; or of tenant administrative interfaces.

Akash Portal

Akash portal collectively refers to all portal interfaces supported by Akash. The portal itself presents a secure, strongly authenticated point of control for various actors of Akash services to the extent they are entitled and the role or context they access the portal.

Tenant Enrollment

Akash uses a transitive trust model based on well-known Public PKI (Public-key Infrastructure) that binds the DNS domain identity to a digital certificate as the basis for enrolling a tenant (e.g., MSP, large enterprise) online.

Akash itself publishes its public key certificate (and required Certificate Policies—CP and Practice Statement CPS) obtained from a well-known Certificate Authority. The enrolling tenant uses this as the basis for establishing an initial M-TLS (mutual TLS) session.

Over this M-TLS channel—the tenant runs a certificate-enrollment protocol (SCEP) submitting a public key of the keypair it has generated (CSR—Certificate Signing Request) for issuance of a digital certificate signed by Akash's CA (a signing authority which may or may not be rooted in an external CA).

Note that Akash CA service runs as part of the System Management subsystem which is a singleton (highly available and running geo-redundant in another region).

Akash portal forwards the SCEP request to the CA which validates the request in conjunction with a passcode issued out-of-band to the tenant (e.g., MSP). The SCEP protocol carries a passcode indicating that the requesting session context is authorized to make the request (since any privileged entity capable of using the original tenant certificate may have established the M-TLS session; that alone is not sufficient to grant the certificate against the CSR—certificate signing request)

Akash requires enrollment and issuance of this new digital certificate to anchor the trust with its CA; and for separation of interests in unknown other usages related to the already existing external certificate of the tenant (used for establishing the aforementioned M-TLS session).

A tenant may have geographically distributed Points of Presence (PoPs). The PoPs interfacing to Akash independently will need to be likewise provisioned with digital certificates. They can be accomplished in this same session context or updated later.

FIG. 18 Enrollment Sequence for a MSP Tenant

The enrollment process requires additional steps to facilitate configuration of specific policies. These may be accomplished through web-interface off the tenant-administrator console or alternately programmatically (as depicted in the FIG. 18). Both are accomplished in the backend using tenant-administration interface APIs.

This includes optional build of tenant (subscriber-)user-directory by import or explicit entries—programmatically or through the admin-GUI. The subscriber-directory is optional based on the services subscribed.

The sequence of enrollment is stated as follows:

1. The tenant establishes a M-TLS connection to Akash

2. The tenant submits a CSR over SCEP protocol through the established M-TLS.

3. The Akash portal forwards request for processing to Akash's CA (Akash may serve as RA to an external CA to vouch for the tenant credentials)

4. The CA validates the CSR against the passcode provisioned in the System-management tenant database.

5. The tenant is issued the certificate (with the public-key embedded in it) and the CSR is returned successfully.

6. Tenant repeats the request for other PoPs, if needed—this time using the new context established through the new M-TLS session over the issued X509v3 certificate.
a. Alternately—henceforth the tenant may proceed to make such requests through portal GUI.

Akash aims to offer rich internet services such as commune-collaboration which facilitates of user-specified communes that can have a specified lifetime and endowed with commune-specific privileges by configuration. Participants can be from other tenants or outside of Akash (but authenticated appropriately and authorized by sponsorship by the commune sponsor). The creator of the commune is the owner and accounts for the Akash resources and services leased through and to the commune.

Web-Based Subscription and User-Access

Rich endpoint services through self-service portal is one of the highlights of the Cloud service orchestration process. The web-portal based interfaces offer the control plane interface to the endpoint into the self-provisionable features and functions—at runtime and long-term subscription features. To be clear, the traditional video-conference session orchestration by exercising minimal control features (over the signaling path) continues to be supported.

The rich web-based services go hand in hand with soft endpoints—either embedded in browser—or as thick clients of today; the binding between a video session and the accountable session-organizer's web-login context offers a way for the tenant to verifiably bind the video-display waiting at the Akash lobby and the web-session before conferencing resources are made available and user allowed in. The classic user interfaces of non-web video endpoints such as HDX, room, ITP and VVX and the associated look and feel are preserved as well. Moreover, a hybrid model of web-based self-service on the client; can be combined with the classic display (where the control endpoint is physically different from the video-session endpoint is also supported. The binding of such a model is specified as below.

Akash exposes rich user interfaces through application enablement through RESTful APIs. As a result—this enables secure access to a wide range of endpoints to the conference organizer (subscriber) and to the participant using a combination of rich UC messaging (email & web) and web-based authentication and authorization. In this mode, the user engages in a video web-portal access with an Akash web-portal. The sequence could be as follows: (Refer to FIG. 19)

1. Web-client (user@acme.tenant.com accesses the Akash portal (akash.com)
a. There could be several variants. The initial access could be to authenticated tenant portal with options to goto Akash portal with auth-token delivered by tenant.

2. If not already authenticated and without a token: Akash redirects client to Tenant portal
a. Authenticate client (since not authenticated already)

3. Redirect client back to the Akash portal with token and authorization token.

4. Akash portal verifies token and, as needed goes to Tenant backend to get additional authorizations, as needed.

5. Akash presents the user with choice of video-session options.
a. Use an embedded m100-client in browser
b. Use a federated client (gtalk or skype)
c Use an existing endpoint (such as HDX, VVX, . . . ): H.323 or SIP

6. The GUI also presents options to schedule or setup ad-hoc calls
a. Presents interface to specify participants-list to be notified.
b. Presented with a choice of layouts—depending on nature of conference: lecture, one-one, or collaborative meeting.
   i. This is an (inspired) higher-level representation of hints that can be provided to far-end services on choice of codecs and modes (SVC or AVC)—if both are permitted by endpoints

7. Akash portal back-end invokes the session-manager's email client to issue email notifications with the session-code (VMR) and participant passcode.

The authentication sequence plays out slightly differently when OAUTH is used (note that OAUTH is not the optimal mechanism to use for this purpose):

1. Web-client (user@acme.tenant.com accesses the Akash portal (akash.com)

2. Akash redirects client to tenant portal (tenant.com).

3. Tenant-portal authenticates client if needed.

4. It then examines the redirected request further to see Akash has requested authentication of user for authorized access to its resources.

5. Indirectly—tenant provides approval to the resources by indicating authentication through the OAUTH token.

This protocol is not the normal case. This is known as pseudo-authentication using the OAUTH token. The more appropriate mechanism to use the federated authentication indicated at first (using, e.g., SAML SSO) or OpenID—where Tenant serves as the Identity Provider (IdP) authenticating the user; and an OpenID provider may be supported by anyone who is serving the subscriber and trusted by the IdP and Akash. It is possible for Akash itself to serve as the OpenID provider. However, whether OpenID is used by Tenant portal is transparent to the Akash portal—which just needs to know from tenant that the user is authorized.

The OpenID sequence can be as follows:

1. Akash portal access by user is redirected to tenant portal.

2. Tenant portal challenges user with OpenID authentication offer. The user submits the openID URL identity

3. The user is redirected to the OpenID provider (which may optionally engage in a backend D-H exchange with the tenant for secure transactions.

4. The OpenID provider then challenges the user for OpenID authentication. Once successful

5. The user is redirected to the tenant portal with appropriate user credentials which the tenant validates.

6. It then redirects the original end-user request back to Akash portal (which still requires some form of trust-authorization to Akash).

Hybrid Service Access with Classic Endpoints

This is with reference to FIG. 20. A classical endpoint can be the input-restricted endpoints such as HDX and VVX and ITP—be they SIP or H.323 it does not matter. After the initial interactions to perform web-based login, the organizer (subscriber) opts to enter an ad-hoc conference while inviting participants into it:

1. Use the endpoint to register and authenticate to the said IP address-port pair (of Akash portal) as specified in the webpage.

2. The user is challenged with a video IVR providing a code to be entered into the webpage for binding a valid subscriber to this display.

3. Upon entering the valid code through the browser; the subscriber is entered into the portal (the backend validates the code against the one provided at the display).

4. The tenant portal proceeds to admit the organizer to a VMR by forwarding the INVITE request to the Akash conference portal (with asserted identity/role)—which allocates the VMR and joins the organizer to the call with the conference focus.

At the participant end:

5. Upon receipt of an email from the Akash portal, the participant attempts to join by clicking on the URL.

6. The URL takes the participant to the Akash portal which validates the participant identity (it could be a weak trivial validation as present in the URL or strong authentication based on OpenID from the Identity Provider of the domain of the participant; there's an implication that Akash trusts the domain and it has OpenID support). Psuedo-OAUTH may be used as well.

If the participant is associated with a classical endpoint—a similar sequence plays out as with a code at the video IVR to be entered into the web-browser of the participant to finalize the binding. The tenant forwards the INVITE request and asserts identity as participant to Akash portal causing the appropriate policies to be applied to the participant after letting the participant join the conference (focus).

Pure Classic Endpoints

This section discusses the case of all-classical endpoint client (refer to FIG. 21) without a web-based device for control. This becomes a subset of the sequence of FIG. 20 discussed above.

OpenID

OpenID is the protocol and mechanism that is intended for easing the burden on end-users on the internet authenticating to multiple domains to be automated to an authentication to one common trusted Identity Provider (OpenID Provider) which then asserts the identity to different (trusting) serving domains. This is widely supported by many public domain application service providers (e.g., Google, Facebook, Yahoo, twitter). Any one of them may serve as an OpenID providers recognized by others (not limited to the example service provider parties listed above).

OpenID, hence, is basically an internet-based SSO for end-users. There are several well-known standalone OpenID providers, notably, www.openid.org.

Akash aims to support OpenID for the following reasons

1. Support of identity-validation assertion by participant domains. For example, an invited participant (even outside of any Akash tenancy) can be verified by referring the user to one of several Akash-trusted OpenID Providers (trust-anchors).

2. Akash Commune: verifying the enrollment of an invited participant by verifying an identity of the participant when belonging to a trusted domain.

Alternately, this may also be done by email verification sequence common in many internet-enrollment methods (with due DoS protection through Captcha and related mechanisms).

Other Federated SSO

SAML-based SSO, commonly used in enterprise SSO, but initially intended for and widely used web-SSO profiles may also be used to authenticate/authorize users.

Authorization & Policies

OAUTH

OAUTH is essentially a authorization delegation protocol. However, a degenerate application for OAUTH protocol is for (delegated) authentication indirectly or explicitly authorizing a service provider to deliver service.

Threat Model

Akash deployment, as a Cloud service, in and of itself, in any commercial (SAS70 and ISO2001) certified Cloud infrastructure would be considered to be protected by a network firewall. All instances started off in the IaaS can be initialized with all network ports disabled (deny-all) other than management console (running SSH using asymmetric key authentication).

Security & Privacy Considerations

Cloud as the base is a vantage point for delivering services over the internet on a massive scale and worldwide. Cloud also exposes Akash architecture to internet elements that it needs to be protecting with the principles of CIA (Confidentiality, Integrity and Availability).

### Load Balancing of a Conference Server Example

Referring to FIGS. 22, 23 and 24 A through 24 D information pertaining to a load balancing example is provided here. This information is most closely related to the second embodiment described above although may be combined with other embodiments.

Regarding FIG. 22:

1). A Master Session director which is controlling pool of session director.

2). Master Session director keeps track of at least two things
a.) Mapping between Destination ID (Conference ID) & the Session director for active sessions.
b.) Current load on all the Session Director (which is sum of load available on all the DMA).
c.) Also note, there can be a subscription between Session director and Master session director.

3). Session director in this scenario will have their separate pool of DMA+MCU.

4). There can be a centralized Conference load balancer table, accessible by all the Session directors. This CLBT keeps a record of VMR (Conference ID) and the list of active DMA (Where currently conference is hosted).

For example:

| Conference ID | List of DMA | |
|---|---|---|
| 1234 | IP | Status |
| | x.x.x.x | full |
| | a.a.a.a | active |

5). Session director can have a local copy of the CLBT table, if there are any update/write on the table, CLBT component can push it to all the Session directors.

Regarding FIG. 23 a flow chart for constant cost routing of a participant session to a destination DMA is shown.

Regarding FIGS. 24 A-D different calling scenarios are described by the following time-line descriptions:

FIG. 24 A illustrates a user placing a first call. First a user makes a conference Call, after passing through proxies (not included in the diagram) it hits the Master Session director. Next, MSD (Master Session director) checks if there is any active session map for this conference ID. If YES then it forwards that call to the Session director (SD). The Session director checks the active subscription for the VMR and extracts the DMA IP from the subscription information. The Session director then redirected the call to the DMA IP and redirection goes back to the Master Session director and then finally to the endpoint where the endpoint places a call directly to the DMA. If NO then the Master Session director selects the least loaded SD and forwards the request to the selected SD. The selected SD checks if there is any active subscription that exists for the VMR and if yes it returns the DMA IP in redirect response. If no active subscription entry exists the Session director does a query to the Conference Load Balancer Table (CBLT). If SD doesn't get an entry in the query response, then it selects the least loaded DMA from its pool of available DMA. The Session director updates the CBLT with the DMA entry. Session director send the DMA IP in the redirect response to the Master Session director and finally to the endpoint. The Session director creates a subscription channel between DMA-SD for this VMR. This subscription channel will keep on updating the SD about the status of the conference call and the load on the DMA.

FIG. 24 B illustrates a second user joining the call. First a user makes a conference call and after passing through proxies (not included in the diagram) the call hits the Master Session director. Next the MSD (master session director) checks if there is any active session map for this conference ID. It forwards that call to the session director. The SD checks the active subscription for the VMR and extracts the DMA IP from the subscription information. The SD then redirects the call to the DMA IP. Redirection goes back to the MSD and then finally to the endpoint. The endpoint places a call directly to the DMA.

FIG. 24 C illustrates an Nth user joining a call when a DMA is overloaded. First a user makes a conference call. After passing through proxies (not included in the diagram) the call hits the MSD. The MSD checks if there is any active session map for this conference ID. If YES the call is forwarded to the SD. The SD checks the active subscriptions for the VMR and extracts the DMA IP from the subscription information. If the DMA where call is hosted is overloaded, then the SD selects a new DMA to host this conference call. The SD adds this new DMA entry into the CLBT and marks the previous DMA as full/overloaded. The SD returns the IP of the new DMA in the response (Rest of call flow is same as use case of FIG. 24 A). Once call lands on the DMA of the new SD both the DMAs (the overloaded and the new one) join each other's conference call as a conference participant and keep the context of the conference the same.

FIG. 24 D illustrates an Nth user joining a call with both the SD and the DMA are overloaded. First a user makes a conference call and after passing through proxies (not included in the diagram) the call hits the MSD. the MSD checks if there is any active session map for this conference ID. If the SD is overloaded then MSD selects the other SD. The MSD forwards the call to the newly selected SD. The new SD checks the active subscription for the VMR. If there is no subscription, the SD queries the CLBT and gets the response back with the DMA IP and its status. In this case CLBT returns the entry with the existing DMA IP with is full/overloaded status. Next the SD selects a new DMA from its pool. The SD adds this DMA into the list of conference ID entry into the CLBT. This way CLBT will contain two (or more than two) entries of DMA where conference is hosted and their status. The SD will routes the call to the active DMA. The rest of the sequence is the same as use case of FIG. 24 A. In addition to this, both of the DMAs add each other into their conference and keep the context of the conference.

By using this method of load balancing we are achieving the linear elasticity. Search to find the appropriate DMA goes linearly and it provides an architecture to scale the conference server by keeping the context of the conference same across the distributed DMA (conference servers).

What is claimed is:

1. A method for policy based adaptive proportional cloud resource allocation to support a multi-media conference, the method comprising:
receiving information from a plurality of broker agents at a resource management module, the information concerning availability of cloud compute resources, multi-media session management, availability of configured cloud based soft multi-media control units (MCUs), and user access information;
coordinating availability and connectivity of a plurality of soft MCUs supporting a scaleable video conference for a plurality of users at a plurality of endpoints by utilizing user access information to manage the allocation of the plurality of soft MCUs.

2. The method of claim 1, wherein the plurality of endpoints comprise at least two endpoints running different client connection protocols to a single multi-media conference.

3. The method of claim 1, wherein the broker agents are configured to interface to a plurality of different virtual data center providers to support a single multi-media conference.

4. The method of claim 1, wherein the resource management module receives a request to add an additional instance of a soft MCU from at least one of the plurality of broker agents, the request generated based on additional users joining the multi-media conference.

5. The method of claim 1, wherein the resource management module receives a request to quiesce an instance of a soft MCU from at least one of the plurality of broker agents, the request based on users disconnecting from the multi-media conference.

6. The method of claim 5, wherein the resource management module releases cloud based resources associated with the instance of the soft MCU after the instance of the soft MCU has been quiesced.

7. The method of claim 1, wherein each of the plurality of broker agents communicates with other broker agents and patterns of allocations are maintained for use in future adaptation of broker policies.

8. The method of claim 1, wherein the information from the plurality of broker agents causes the resource management module to instantiate an additional multi-media session management module for the multi-media conference.

9. A non-transitory computer readable medium having instructions stored thereon that when executed cause a processor to:
receive information from a plurality of broker agents at a resource management module, the resource management module operable to perform management of cloud based resources to support a multi-media conference, the information concerning availability of cloud compute resources, multi-media session management, availability of configured cloud based soft multi-media control units (MCUs), and user access information;
coordinate availability and connectivity of a plurality of soft MCUs supporting a scaleable video conference for a plurality of users at a plurality of endpoints.

10. The non-transitory computer readable medium of claim 9, wherein the plurality of endpoints comprise at least two endpoints running different client connection protocols to a single multi-media conference.

11. The non-transitory computer readable medium of claim 9, wherein the broker agents are configured to interface to a plurality of different virtual data center providers to support a single multi-media conference.

12. The non-transitory computer readable medium of claim 9, wherein the resource management module receives a request to add an additional instance of a soft MCU from at least one of the plurality of broker agents, the request generated based on additional users joining the multi-media conference.

13. The non-transitory computer readable medium of claim 9, wherein the resource management module receives a request to quiesce an instance of a soft MCU from at least one of the plurality of broker agents, the request based on users disconnecting from the multi-media conference.

14. The non-transitory computer readable medium of claim 9, wherein the resource management module releases cloud based resources associated with the instance of the soft MCU after the instance of the soft MCU has been quiesced.

15. The non-transitory computer readable medium of claim 9, wherein each of the plurality of broker agents communicates with other broker agents and patterns of allocations are maintained for use in future adaptation of broker policies.

16. A system comprising:
one or more processors communicatively coupled to a memory; and
instructions stored in the memory, the instructions associated with a resource manager module, an access service module, a database access module, a session manager module, and a media server module;
wherein the resource manager module is operable to manage cloud based resources to support a plurality of endpoints connected to a multi-media conference, the cloud based resources allocated based on a number of users in the multi-media conference and user connection information;
wherein the access service module is operable to coordinate and authenticate user access to the multi-media conference;
wherein the database access module is operable to maintain information in a database about users of the multi-media conference and resource usage of the multi-media conference;
wherein the session manager module is operable to:
maintain the state of the signaling sessions;
instantiate MCU resources as needed based on an external entity requisitioning additional resources for a multi-media conference; and
call control information associated with the multi-media conference; and
wherein the media server module is operable to maintain virtual meeting rooms and associations of multiple soft MCUs with each virtual meeting room.

17. The system of claim 16, wherein the resource manager module is further operable to maintain a pool of idle soft MCUs in an available state for allocating to the multi-media conference upon request.

18. The system of claim 17, wherein the resource manager module is further operable to return a soft MCU to the pool if idle soft MCUs based upon users disconnecting from a multi-media conference.

19. The system of claim 16, wherein a plurality of broker agents communicates with other broker agents and patterns of allocations are maintained for use in future adaptation of broker policies.
